(19) United States
(12) Patent Application Publication
(10) Pub. No.: US 2022/0078317 A1
(43) Pub. Date: Mar. 10, 2022

(54) ELECTRONIC DEVICE

(71) Applicant: GUANGDONG OPPO MOBILE TELECOMMUNICATIONS CORP., LTD., Dongguan (CN)

(72) Inventors: Qiang WANG, Dongguan (CN); Maozhao HUANG, Dongguan (CN); Biao LI, Dongguan (CN)

(21) Appl. No.: 17/528,186

(22) Filed: Nov. 16, 2021

Related U.S. Application Data
(63) Continuation of application No. PCT/CN2020/083623, filed on Apr. 8, 2020.

(30) Foreign Application Priority Data
May 24, 2019 (CN) 201920758202.0

(51) Int. Cl. H04N 5/225; H04N 5/247; H04M 1/02

(52) U.S. Cl. CPC H04N 5/2257; H04M 1/0264; H04N 5/247; H04N 5/2253

(57) ABSTRACT

Provided is an electronic device including a main body and a mounting base. The main body includes a display screen module, and a mounting groove provided at a rear side of the main body. A groove wall of the mounting groove is provided with a sound output channel. The mounting base includes a receiver and a camera module, and is rotatable relative to the main body to switch between a first position and a second position. As the mounting base is in the first position, the mounting base is accommodated in the mounting groove, the camera module is exposed to the rear side, and the receiver outputs sound through the sound output channel. As the mounting base is in the second position, the camera module is exposed to a front side of the main body.

### CROSS-REFERENCE TO RELATED APPLICATION

This application a continuation of International Patent Application No. PCT/CN2020/083623, filed on Apr. 8, 2020, which claims priority to Chinese Patent Application No. 201920758202.0, filed on May 24, 2019, the entire disclosures of which are incorporated herein by reference.

### TECHNICAL FIELD

The present disclosure relates to the field of terminal technologies, and in particular to an electronic device.

### BACKGROUND

A front camera is generally provided on a side of a mobile terminal where a display area of display screen of the electronic device is located, and it is difficult to make the front camera serve as a rear camera.

### SUMMARY

An electronic device is provided. The electronic device includes a main body and a mounting base. The main body includes a display screen module. The main body has a front side and a rear side of opposite to the front side, and the front side of the main body is defined as a side where a display area of the display screen module is located. A mounting groove is provided at the rear side of the main body, and a sound output channel is provided in a groove wall of the mounting groove and is communicated with the front side of the main body. The mounting base includes a receiver and a first camera module. The mounting base is rotatable relative to the main body to switch between a first position and a second position. As the mounting base is in the first position, the mounting base is accommodated in the mounting groove, the first camera module is exposed to the rear side of the main body, and the receiver is enabled to output sound through the sound output channel. And as the mounting base is in the second position, the mounting base is out of the mounting groove, the first camera module is exposed to the front side of the main body, and the receiver is enabled to output the sound from the rear side of the main body.

Another electronic device is provided. The electronic device includes a main body and a mounting base. The main body defines a mounting groove at a rear side thereof, and a groove wall of the mounting groove is provided with a sound output channel communicated with a front side of the main body. The mounting base includes a receiver and a camera module. The mounting base is rotatable relative to the main body to switch between a first position and a second position. In the first state, the mounting base is accommodated in the mounting groove, the camera module is exposed to the rear side of the main body, and the receiver is enabled to output sound through the sound output channel. And in the second state, the camera module is exposed to the front side of the main body, and the receiver is enabled to output the sound from the rear side of the main body.

A further electronic device is provided. The electronic device includes a main body and a mounting base. The main body includes a display screen module, a middle frame and a rear cover. The display screen module and the rear cover are assembled at two opposite sides of the middle frame. A mounting groove is defined in the middle frame and the rear cover. The middle frame is provided with a sound output channel, the sound output channel is communicated with the mounting groove and a front side of the main body. The front side is defined as a side of the main body where a display area of the display screen module is located. A mounting base includes a receiver and a camera module. The mounting base is rotatable relative to the main body to define a first state and a second state of the electronic device. In the first state, the mounting base is accommodated in the mounting groove, the camera module is exposed to a rear side of the main body, and the receiver is enabled to output sound through the sound output channel. In the second state, the mounting base is out of the mounting groove, the camera module is exposed to the front side of the main body, and the receiver is enabled to output the sound from the rear side of the main body.

### BRIEF DESCRIPTION OF THE DRAWINGS

In order to clearly illustrate the technical solutions in the embodiments of the present disclosure or the related art, drawings used in the description of the embodiments or the related art will be briefly introduced below. Obviously, the drawings in the following description illustrates only some embodiments of the present disclosure, and those of ordinary skill in the art can also obtain drawings of other embodiments according to these drawings without paying any creative work.

FIG. 1 is a rear view of an electronic device according to the embodiments of the disclosure, in which a mounting base of the electronic device is located in a first position.

FIG. 2 is a left view of the electronic device shown in FIG. 1.

FIG. 3 is a main view of the electronic device shown in FIG. 1.

FIG. 4 is a top view of the electronic device shown in FIG. 3.

FIG. 5 is an exploded view of the mounting base of the electronic device shown in FIG. 4 which is illustrated from one viewing angle.

FIG. 6 is a rear view of the electronic device shown in FIG. 1, in which the mounting base of the electronic device is located in a second position.

FIG. 7 is a main view of the electronic device shown in FIG. 6.

FIG. 8 is an exploded view of the mounting base of the electronic device shown in FIG. 4 which is illustrated from another viewing angle.

FIG. 9 is a main view of the mounting base of the electronic device shown in FIG. 4.

FIG. 10 is a cross-sectional view of the mounting base of the electronic device shown in FIG. 9 which is taken along line B-B.

FIG. 11 is an exploded view of the electronic device shown in FIG. 1.

FIG. 12 is an exploded view of the electronic device shown in FIG. 11 with some parts removed.

FIG. 13 is a schematic enlarged view of location A of the electronic device shown in FIG. 1.

FIG. 14 is a partial view of the electronic device shown in FIG. 12.

FIG. 15 is a partial view of the electronic device shown in FIG. 11.

FIG. 16 is a perspective view of an output shaft of the electronic device shown in FIG. 12.

FIG. 17 is an exploded view of the output shaft of the electronic device shown in FIG. 16.

FIG. 18 is a main view of the output shaft of the electronic device shown in FIG. 16.

FIG. 19 is a cross-sectional view of the output shaft of the electronic device shown in FIG. 18 which is taken along line C-C.

FIG. 20 is a structural block diagram of an electronic device provided in the embodiments of the present disclosure.

### DETAILED DESCRIPTION OF PREFERRED EMBODIMENTS

In order to facilitate the understanding of the disclosure, the disclosure will be described below comprehensively with reference to the drawings. The drawings show preferred embodiments of the disclosure. However, this disclosure can be implemented in many different ways, rather than being limited to the embodiments described herein. On the contrary, the embodiments are provided just for the purpose of providing thorough and comprehensive understanding of the disclosure.

The term “electronic device” used herein includes, but is not limited to, devices that can be connected in any one or some of the following connections to receive and/or send communication signals:

(1) Wired connection, for example, the connection is established via Public Switched Telephone Networks (PSTN), Digital Subscriber Line (DSL), a digital cable, and a direct cable; and

(2) Wireless connection, for example, the connection is established via cellular network, Wireless Local Area Network (WLAN), digital television network such as DVB-H network, satellite network, and AM-FM broadcast transmitter.

The electronic devices configured to communicate wirelessly may be referred to as “mobile terminals”. Examples of mobile terminals include, but are not limited to, the following electronic devices:

(1) A satellite phone or cellular phone;

(2) A Personal Communications System (PCS) terminal that can incorporate a cellular radio telephone with capacities of data processing, fax and data communication;

(3) A radio telephone, pager, Internet/Intranet access, Web browser, note book, calendar, Personal Digital Assistant (PDA) equipped with a Global Positioning System (GPS) receiver;

(4) A conventional laptop and/or palmtop receiver; and

(5) A conventional laptop and/or palmtop radio telephone transceiver, etc.

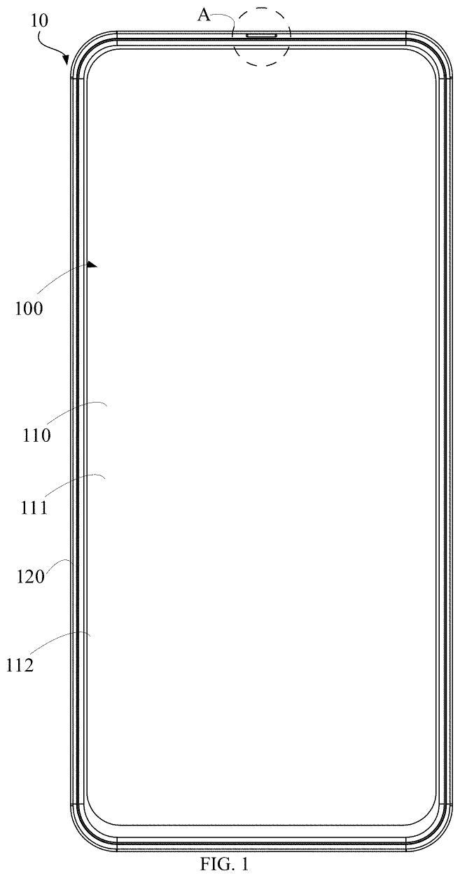

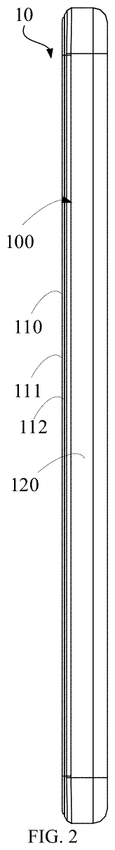

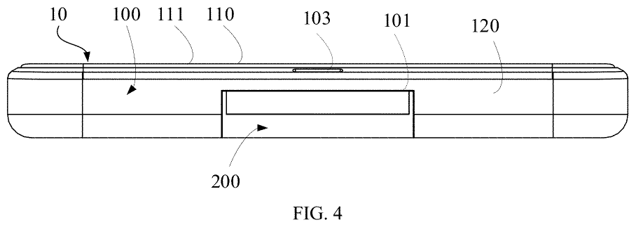

Referring to FIG. 1 to FIG. 4, in some embodiments, an electronic device 10 is a smart phone. The electronic device 10 includes a main body 100 and a mounting base 200. The main body 100 includes a display screen module 110, and the display screen module 110 may be used to display information and provide an interactive interface to a user. The main body 100 has a front side and a rear side opposite to the front side, and the front side of the main body 100 is defined as a side where a display area of the display screen module 110 is located. A mounting groove 101 is provided on the rear side of the main body 100 that is away from the display screen module 110, and a sound output channel 103 is provided in a groove wall of the mounting groove 101 and is communicated with the front side of the main body 100. In some embodiments, the display screen module 110 includes a screen protection cover 111 and a display screen 112, and the screen protection cover 111 covers the display screen 112 to protect the display screen 112. The display screen 112 may be a Liquid Crystal Display (LCD) screen or an Organic Light-Emitting Diode (OLED) screen. The sound output channel 103 extends to the front side of the main body 100, that is, the sound output channel 103 can be observed from the front side of the main body 100.

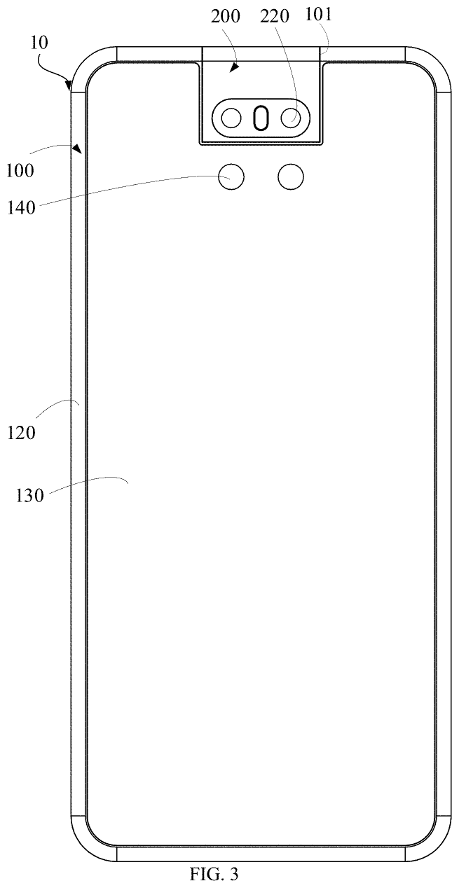

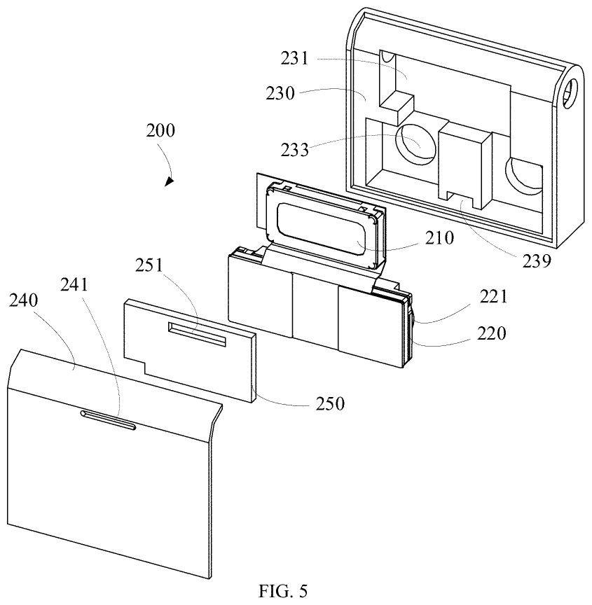

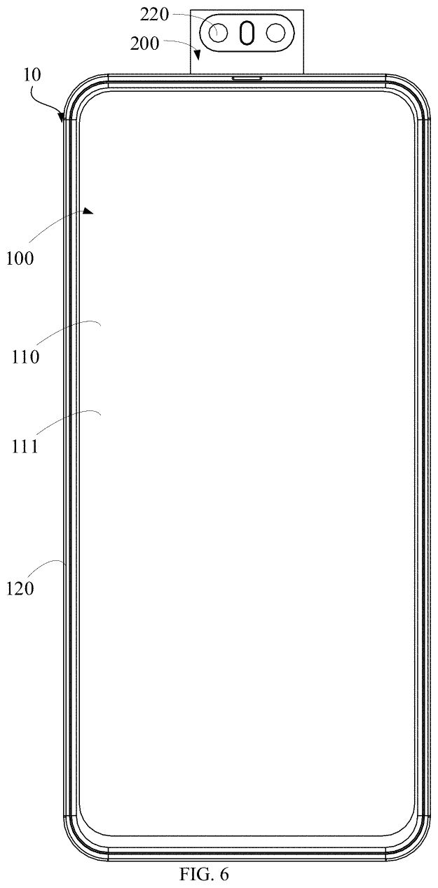

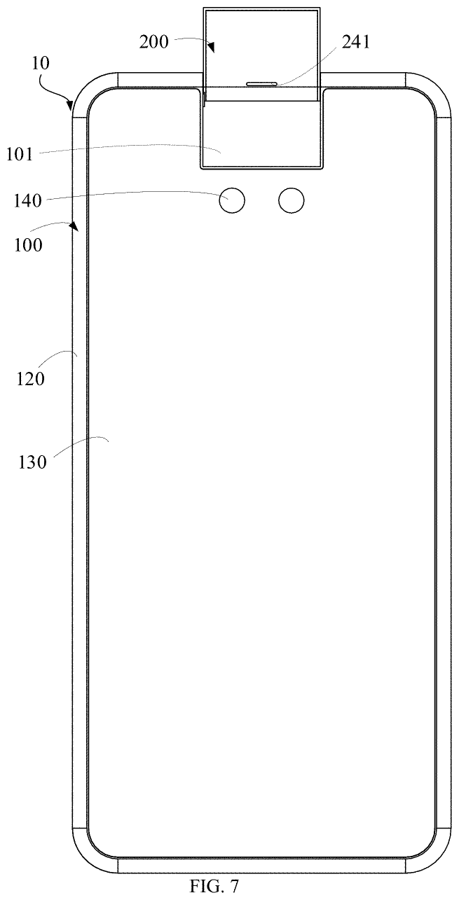

Referring to FIG. 5 to FIG. 7, the mounting base 200 includes a receiver 210 and a first camera module such as a camera module 220. The mounting base 200 is disposed at the mounting groove 101, and is rotated to a first position or a second position relative to the main body 100. Referring to FIG. 1 and FIG. 3, as the mounting base 200 is in the first position, the mounting base 200 is accommodated in the mounting groove 101, the camera module 220 is exposed to the rear side of the main body 100, and the receiver 210 is enabled to output sound through the sound output channel 103, so that the sound can come out of the front side of the main body 100, to facilitate the user to listen to voice messages, such as calls and voice messages. As the mounting base 200 is in the first position, the user may use the camera module 220 as a rear camera. For example, the user may perform operations, such as close-range shooting, long-range shooting, and video recording, via the camera module 220. Referring to FIG. 6 and FIG. 7, as the mounting base 200 is in the second position, the mounting base 200 is out of the mounting groove 101, the camera module 220 is exposed to the front side of the main body 100, and the receiver 210 outputs the sound from the rear side of the main body. As the mounting base 200 is in the second position, the user may use the camera module 220 as a front camera. For example, the user may perform operations, such as self-portraits and video calls, via the camera module 220.

For the above electronic device 10, as the mounting base 200 is in the first position, the camera module 220 is exposed to the rear side of the main body 100, and as the mounting base 200 is in the second position, the mounting base 200 is out of the mounting groove 101, the camera module 220 is exposed to the front side of the main body 100, so that the camera module 220 can be switched between the front and rear cameras, to improve the convenience of use and save the cost of the components. As the mounting base 200 is in the first position, the camera module 220 does not have to occupy an area of the front side of the main body 100, so that a screen-to-body ratio of the electronic device 10 can be increased. For example, the screen-to-body ratio of the electronic device 10 under the above arrangement may be more than 85%. In addition, since the mounting base 200 includes the receiver 210, and the receiver 210 can output sound through the sound output channel 103 as the mounting base 200 is in the first position, a compact arrangement of the components is achieved and the convenience of use is improved.

In some embodiments, as shown in FIG. 7, the mounting base 200 is substantially in shape of a rectangular parallelepiped. The receiver 210 outputs the sound from a side of the mounting base 200, and the camera module 220 receives light from a side of the mounting base 200 that is away from the receiver 210. The receiver 210 outputs the sound from the rear side of the main body 100 as the mounting base 200 is in the second position. That is, as the mounting base 200 is in the second position, the sound of the receiver 210 is transmitted from the rear side of the main body 100, and the voice message can be normally listened to at the front side of the main body 100 due to the transmission characteristics of sound.

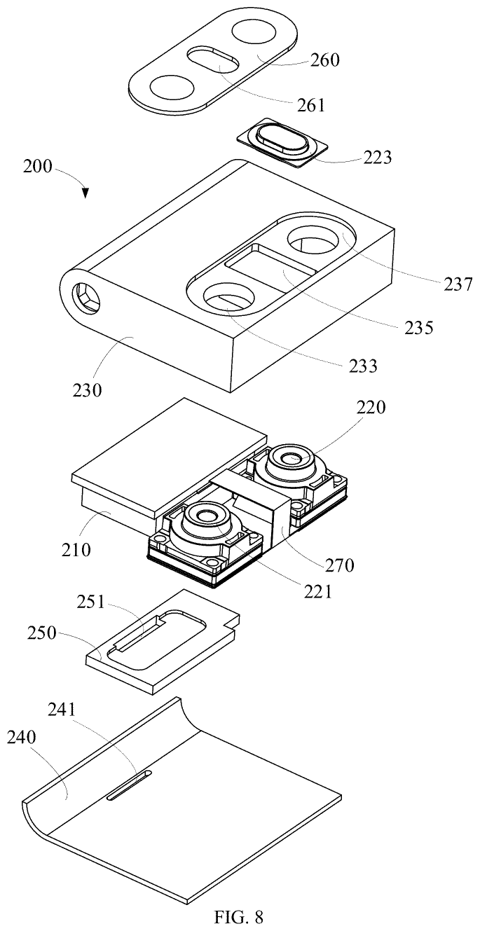

Referring to FIG. 5 and FIG. 8, the mounting base 200 includes a base body 230 and a cover plate 240. The base body 230 may be made of a metal material, such as aluminum alloy or stainless steel. The base body 230 may also be made of a non-metal material, such as plastic. The base body 230 is provided with an accommodation groove 231. The receiver 210 and the camera module 220 are accommodated in the accommodation groove 231, and the cover plate 240 covers the accommodation groove 231. The receiver 210 and the camera module 220 are disposed side by side, the receiver 210 faces towards the cover plate 240, and the camera module 220 faces towards a direction opposite to the cover plate 240. The cover plate 240 is provided with a first sound hole 241 for the receiver 210 to output sound. As the mounting base 200 is in the first position, the first sound hole 241 is communicated with the sound output channel 103. That is, as the mounting base 200 is in the first position, the cover plate 240 is located at a side of the base body 230 facing toward the display screen module 110. As the mounting base 200 is in the second position, the cover plate 240 is exposed to the rear side of the main body 100. The cover plate 240 may be made of a non-metal material, such as glass, plastic, or ceramic. The cover plate 240 may also be made of a metal material, such as aluminum alloy or stainless steel. In some embodiments, the first sound hole 241 is a slit, the sound output channel 103 is also a slit, and as the mounting base 200 is in the first position, the first sound hole 241 and the sound output channel 103 can be aligned and communicated with each other, so that the sound of the receiver 210 can be transmitted to the front side of the main body 100.

Further, the mounting base 200 includes a press plate 250. The press plate 250 is disposed in the accommodation groove 231, and two opposite sides of the press plate 250 respectively abut against the receiver 210 and the cover plate 240. The press plate 250 is provided with a second sound hole 251 for the receiver 210 to output sound, and the second sound hole 251 is communicated with the first sound hole 241. As the mounting base 200 is in the first position, the receiver 210 outputs the sound through the second sound hole 251, the first sound hole 241 and the sound output channel 103. As the mounting base 200 is in the second position, the receiver 210 outputs the sound through the second sound hole 251 and the first sound hole 241. The press plate 250 is used to abut against an end surface of the receiver 210 and an end surface of the cover plate 240, so that the receiver 210 can be reliably fixed in the mounting base 200. In some implementations, the press plate 250 can seal gaps located around the first sound hole 241 and the second sound hole 251. For example, the end surface of the receiver 210 clings to the end surface of the press plate 250 hermetically around the second sound hole 251, and the end surface of the press plate 250 clings to the cover plate 240 hermetically around the first sound hole 241; in this way, the sound is prevented from leaking from a gap between the press plate 250 and the cover plate 240, or a gap between the press plate 250 and the receiver 210, so as to prevent the sound from being broken and improve the sound effect.

Referring to FIG. 8, the base body 230 is provided with a first through hole 233 communicated with the accommodation groove 231. The first through hole 233 is particularly located in a side wall of the base body 230 that is opposite to the cover plate 240. A first dent 235 is provided on the side wall at a side away from the accommodation groove 231, and the first through hole 233 is separated from the first dent 235. The camera module 220 includes at least one camera 221 and a flash 223. The first through hole 233 is used to receive light for the at least one camera 221, and the first dent 235 is used to mount the flash 223. There may be one, or two, or more than two first through holes 233, and the number of the first through holes 233 is the same as the number of the cameras 221. For example, in some embodiments, the camera module 220 includes two cameras 221, and correspondingly, there are two first through holes 233, and the first dent 235 is located between the two first through holes 233. The two cameras 221 may be switched between the rear cameras and the front cameras. Since the rear camera 221 generally adopts a high-pixel camera 221, such arrangement enables the quality of front-facing shooting to be improved, for example, a good self-portrait effect can be achieved. The flash 223 can supply light for the shooting of the camera module 220. For example, in a dark environment, the flash 223 can supply light to improve the shooting quality of the camera module 220.

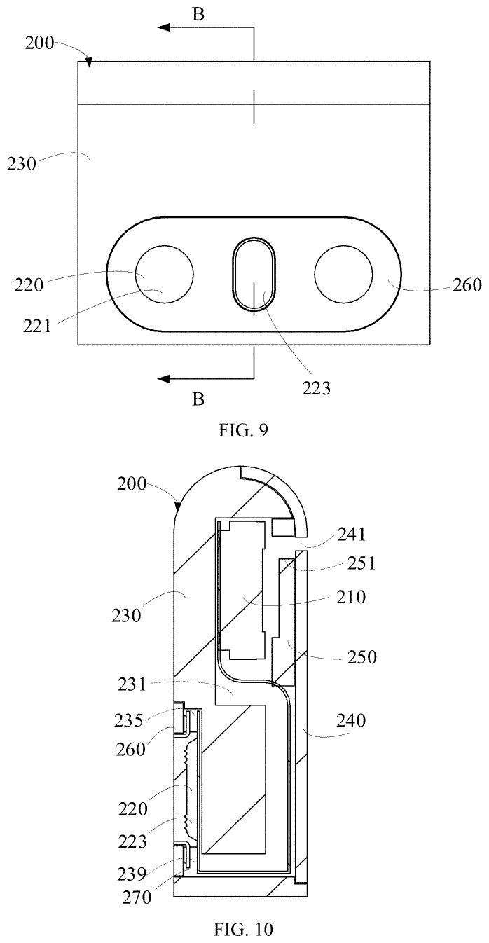

Further, referring to FIG. 8, the base body 230 is provided with a second dent 237, and the second dent 237 is located on the side wall at the same side as the first dent 235. The first through hole 233 and the first dent 235 are located at the bottom of the second dent 237. The mounting base 200 includes a lens cover 260, and the lens cover 260 is disposed in the second dent 237 and covers the at least one camera 221. A light-transmission hole 261 is provided in the lens cover 260, and the flash 223 passes through the light-transmission hole 261. The lens cover 260 may be made of glass or sapphire. The lens cover 260 is used to protect the camera module 220 from being damaged through scratching or collision. Further, referring to FIG. 5, FIG. 9 and FIG. 10, the bottom of the first dent 235 is provided with a second through hole 239 communicated with the accommodation groove 231. The mounting base 200 includes a flexible circuit board 270, and the flexible circuit board 270 passes through the second through hole 239 and is electrically connected with the flash 223. In some embodiments, the camera module 220 also is electrically connected with the flexible circuit board 270, and is connected to a main board of the electronic device 10 via the flexible circuit board 270, so that data and current are transmitted between the camera module 220 and the main board via the flexible circuit board 270.

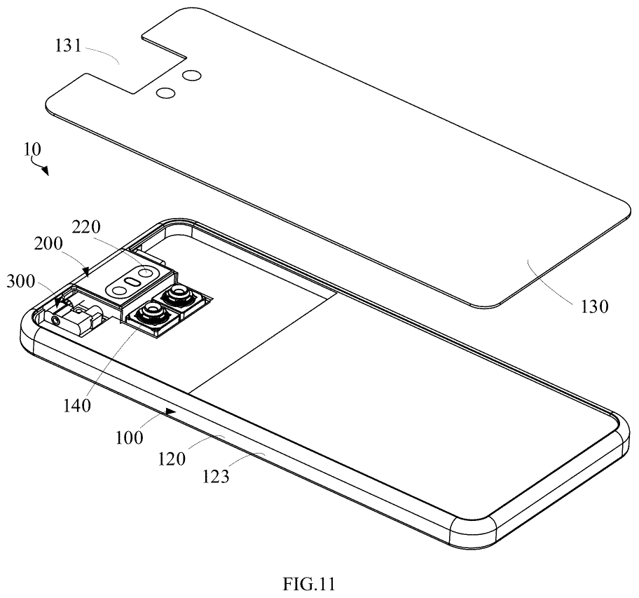

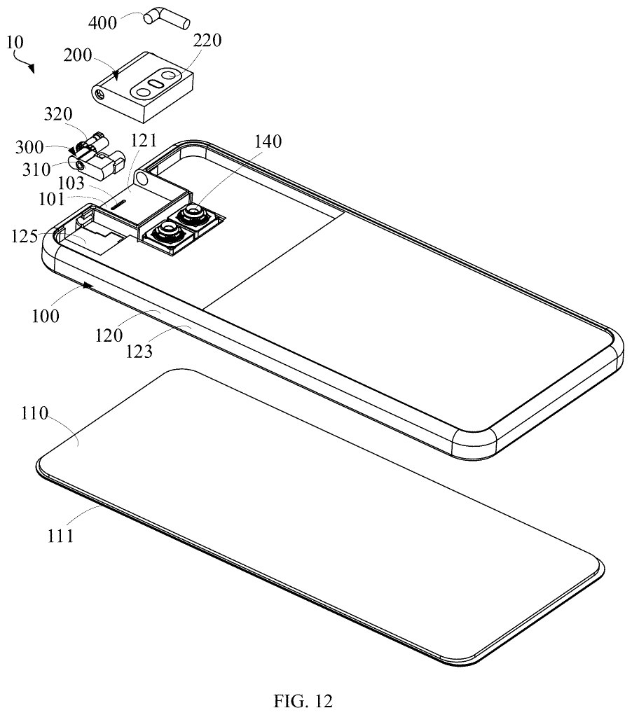

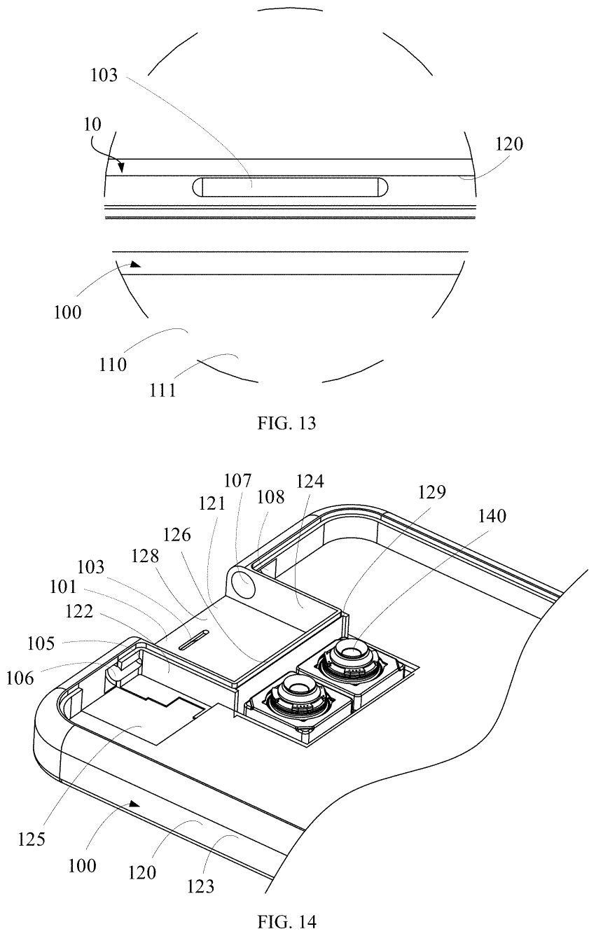

Referring to FIG. 11 and FIG. 12, the main body 100 includes a middle frame 120 and a rear cover 130. The middle frame 120 may be made of aluminum alloy, magnesium alloy, or stainless steel, etc. The rear cover 130 may be made of a non-metallic material, such as glass, ceramic or plastic, or may also be made of a metal material, such as aluminum alloy, or stainless steel. The display screen module 110 and the rear cover 130 are respectively assembled at two opposite sides of the middle frame 120. The mounting groove 101 extends to a side edge of the rear cover 130 to define a first notch 131 in the rear cover 130, and the mounting groove 101 extends to a side edge of the middle frame 120 to define a second notch 121 in the middle frame 120. The sound output channel 103 is located in the middle frame 120 and is communicated with the mounting groove 101 and the front side of the main body 100. Specifically, the middle frame 120 may include a middle plate 125 and an outer frame 123 disposed at an outer periphery of the middle plate 125. The display screen module 110 and the rear cover 130 are respectively assembled, along the thickness direction of the electronic device 10, at two opposite sides of the middle plate 125, and the outer frame 123 is disposed around an outer periphery of each of the display screen module 110 and the rear cover 130. That is, the display screen module 110 and the rear cover 130 are respectively assembled, along the thickness direction of the electronic device 10, at two opposite sides of the middle frame 120. Alternatively, the display screen module 110 and the rear cover 130 are respectively assembled at two opposite sides of the outer frame 123. A mounting space is defined between the middle frame 120 and the rear cover 130, and the mounting space may be used to mount electronic components of the electronic device 10, such as the main board and a battery. The mounting groove 101 runs through a part of the outer frame 123 to form the second notch 121. A side of the outer frame 123 away from the rear cover 130 is disposed around the outer periphery of the display screen module 110, and at the mounting groove 101, a part of the outer frame 123 is passed through by the mounting groove 101, and the other part of the outer frame 123 is continuous or connected to form a continuous structure, and the sound output channel 103 is provided in the part of the outer frame 123 that is passed through by the mounting groove, as shown in FIG. 13. In this way, a hole for outputting sound is prevented from being provided in the screen protection cover 111 of the display screen module 110, and the screen protection cover 111 can maintain a relatively regular shape, and the display area of the display screen module 110 can be increased to improve the screen-to-body ratio of the electronic device 10.

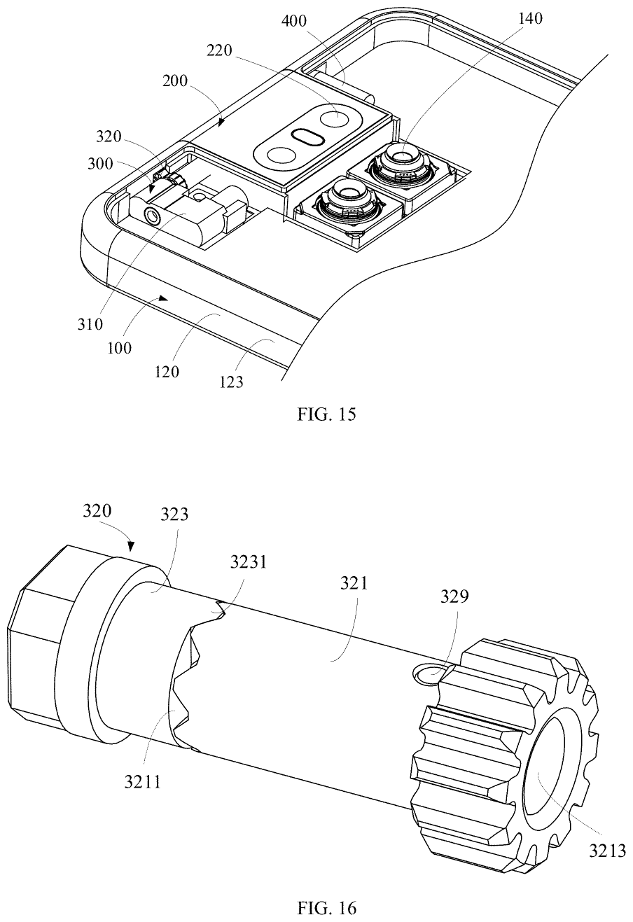

Referring to FIG. 14 and FIG. 15, the middle frame 120 includes a first side wall 122 and a second side wall 124 disposed opposite to each other, and includes a third side wall 126 and a bottom wall 128 which are connected between the first side wall 122 and the second side wall 124. The first side wall 122, the second side wall 124 and the third side wall 126 are disposed on and perpendicular to the middle plate 125, and an end of each of the first side wall 122 and the second side wall 124 is connected to the outer frame 123. The first side wall 122, the second side wall 124 and the third side wall 126 are disposed at an outer periphery of the bottom wall 128, and the mounting groove 101 is defined by the bottom wall 128, the first side wall 122, the second side wall 124 and the third side wall 126. The sound output channel 103 is located in the bottom wall 128. Of course, the sound output channel 103 may also be disposed at the first side wall 122 or the second side wall 124. At least one of the first side wall 122, the second side wall 124, and the third side wall 126 forms a step having a step surface 129 on a side thereof away from the mounting groove 101, and there is a height difference between the step surface 129 and an end face of each of the first side wall 122, the second side wall 124 and the third side wall 126 that is away from the bottom wall 128. The step surface 129 is lower than the end face of each of the first side wall 122, the second side wall 124 and the third side wall 126 that is away from the bottom wall 128. The rear cover 130 is attached onto the step surface 129, and the sides of the first side wall 122, the second side wall 124, and the third side wall 126 that are away from the bottom wall 128 pass through the first notch 131. Such arrangement is beneficial to the stability of the structure of the mounting groove 101, and is beneficial to the waterproof and dustproof performance of the electronic device 10. For example, by means of the design of the first side wall 122, the second side wall 124, and the third side wall 126, and the connection between the step surface 129 and the rear cover 130, not only the rear cover 130 can be stably supported, but also a sealing processing can be made between the rear cover 130 and the step surface 129, for example, a sealant is applied therebetween, to improve the waterproof and dustproof performance of the electronic device 10.

Further, a second camera module, including at least one further camera 140, is provided on the side of the third side wall 126 away from the mounting groove 101, and the second camera module is accommodated in the mounting space defined between the middle frame 120 and the rear cover 130. The camera 140 is adjacent to the third side wall and faces towards the rear cover 130, and the rear cover 130 is provided with a light-transmission area for the camera 140 to receive light. In some embodiments, the rear cover 130 is made of glass. The rear cover 130 made of glass has a relatively high light transmittance, for example, the light transmittance thereof may be more than 85%. Therefore, there may be no need for the rear cover 130 to provide an opening to allow light transmission for the camera 140, and the camera 140 can receive light normally through the light-transmission area. In other implementations, the rear cover 130 may be made of a material with low light transmittance, such as metal, ceramic and plastic, and the rear cover 130 may be provided therein with an opening for another camera module 220 to receive light. In this case, the opening may serve as the light-transmitting area.

In some embodiments, the first side wall 122 is provided with a shaft hole 105 communicated with the mounting groove 101. The electronic device 10 includes a driving mechanism 300 disposed within the mounting space defined between the middle frame 120 and the rear cover 130. The driving mechanism 300 includes a driver 310 and an output shaft 320 connected with each other. The driver 310 is connected with the middle plate 125, and the output shaft 320 is connected with the mounting base 200. The driver 310 is used to drive the output shaft 320 to rotate, to drive the mounting base 200 to rotate. Further, the output shaft 320 of the driving mechanism 300 passes through the shaft hole 105, the shaft hole 105 extends to the outer frame 123 to define a first recess 106 in the outer frame 123, and at least a part of the output shaft 320 of the driving mechanism 300 is accommodated in the first recess 106. Since such arrangement utilizes the internal structure of the outer frame 123, the output shaft 320 of the drive mechanism 300 can be as close as possible to an outer edge of the outer frame 123, and thus the drive mechanism 300 can be as close as possible to the outer frame 123, thereby facilitating compact arrangement of the internal components of the electronic device 10.

Further, the second side wall 124 is provided with a hole 107 penetrating the second side wall 124 and communicated with the mounting groove 101. The hole 107 extends to the outer frame 123 to define a second recess 108 in the outer frame 123. The electronic device 10 includes a wire pipe 400. The wire pipe 400 passes through the hole 107 to access the mounting base 200, and at least a part of the wire pipe 400 is accommodated in the second recess 108. The wire pipe 400 has a hollow structure and may be used to accommodate connection wires, so that the electronic components in the mounting base 200 can be powered or communicate with the main board of the electronic device 10. Since such arrangement utilizes the internal structure of the outer frame 123, the wire pipe 400 can be as close as possible to the outer edge of the outer frame 123, and the wire pipe 400 can be as close as possible to the outer frame 123, thereby facilitating compact arrangement of the internal components of the electronic device 10.

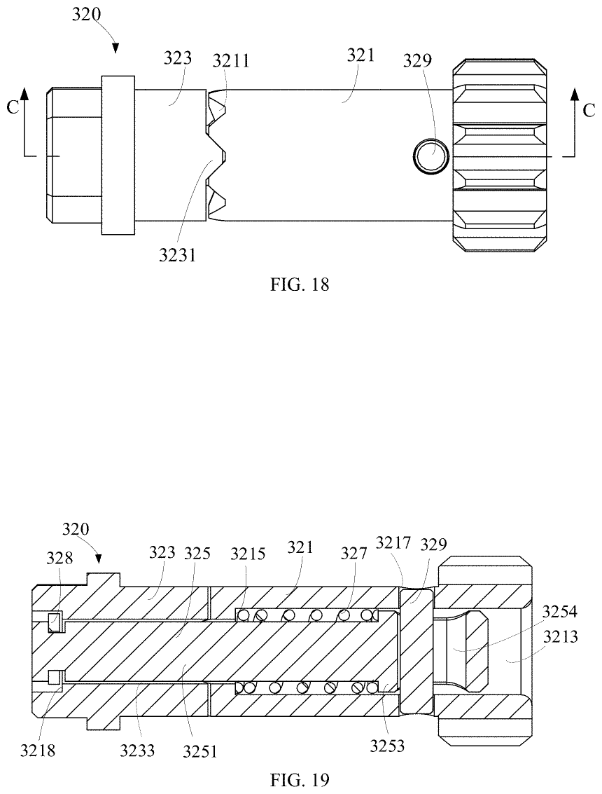

Referring to FIG. 16 to FIG. 19, the output shaft 320 includes a first shaft sleeve 321 and a second shaft sleeve 323. The first shaft sleeve 321 is driven by the driver 310, and the second shaft sleeve 323 is fixedly connected with the mounting base 200. One of the first shaft sleeve 321 and the second shaft sleeve 323 is provided with a clamping slot 3211, the other of the first shaft sleeve 321 and the second shaft sleeve 323 is provided with a protrusion 3231, and the protrusion 3231 is received in the clamping slot 3211, so that the first shaft sleeve 321 can drive, via the second shaft sleeve 323, the mounting base 200 to rotate relative to the main body 100. In some embodiments, one end of the first shaft sleeve 321 is provided with a first gear, and an output end of the driver 310 is provided with a second gear, and the second gear is engaged with the first gear, so that the driver 310 can drive the second shaft sleeve 323 to rotate. In other implementations, the output end of the driver 310 may be provided with a worm gear, and the first shaft sleeve 321 is set as a worm screw, and the transmission is enabled through the engagement of the worm gear and the worm screw, which is not repeated here.

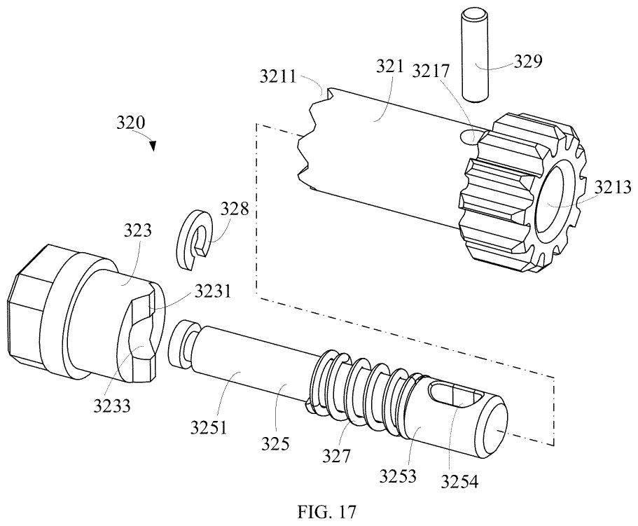

Further, referring to FIG. 17 and FIG. 19, the output shaft 320 includes a shaft rod 325, an elastic member 327 and a position-limiting member 329. The first shaft sleeve 321 is provided with a first mounting hole 3213, and the second shaft sleeve 323 is provided with a second mounting hole 3233. The first mounting hole 3213 runs through the first shaft sleeve 321 along an axial direction of the first shaft sleeve 321, and the second mounting hole 3233 runs through the second shaft sleeve 323 along an axial direction of the second shaft sleeve 323. The shaft rod 325 includes a shaft body 3251 and a connection portion 3253 connected with the shaft body 3251. A part of the shaft body 3251 passes through the first mounting hole 3213, the other part of the shaft body 3251 passes through the second mounting hole 3233, and the connection portion 3253 is received in the first mounting hole 3213. A step 3215 is formed on an inner wall of the first mounting hole 3213, and the inner diameter of a part of the first mounting hole 3213 where the step is formed is larger than the inner diameter of other part of the first mounting hole 3213. The elastic member 327 is accommodated in the part of the first mounting hole 3213 having a larger inner diameter and is sleeved on the shaft body 3251. One end of the elastic member 327 abuts against the step 3215, and the other end of the elastic member 327 abuts against the connection portion 3253. The connection portion 3253 is provided with a position-limiting hole 3254. The first shaft sleeve 321 is provided with a clamping hole 3217 along a radial direction of the first shaft sleeve 321. The position-limiting member 329 passes through the clamping hole 3217 and is fixed to the first shaft sleeve 321, and the position-limiting member 329 passes through the position-limiting hole 3254. Rotation of the first shaft sleeve 321 drives, via the position-limiting member 329, the shaft rod 325 to rotate, and as the mounting base 200 is driven to rotate to the first position or the second position, the protrusion 3231 can be detached from the clamping slot 3211, so that the first shaft sleeve 321 moves in a direction away from the second shaft sleeve 323 and compresses the elastic member 327, and the position-limiting member 329 moves within the position-limiting hole 3254 in the direction away from the second shaft sleeve 323. By means of such arrangement, as the mounting base 200 is rotated to the first position or the second position, the mounting base 200 abuts against the middle frame 120, the mounting base 200 cannot continue rotating, and the second shaft sleeve 323 cannot continue rotating, whereas the first shaft sleeve 321 can continue rotating and produce jitters along the axial direction of the first shaft sleeve 321. The jitters can prevent the drive mechanism 300 from being damaged, and can generate a clear feedback. For example, as the mounting base 200 is rotated to the first position or the second position, the electronic device 10 will produce click-clack and vibrations to enhance the user experience.

Further, referring to FIG. 17 and FIG. 19, the output shaft 320 includes a snap ring 328, the snap ring 328 is clamped in a groove provided at an end of the shaft body 3251 away from the connection portion 3253. A step 3218 is formed on an inner wall of the second mounting hole 3233, and the inner diameter of a part of the second mounting hole 3233 where the step 3218 is formed is larger than the inner diameter of other part of the second mounting hole 3233. During the process that the protrusion 3231 is detached from the clamping slot 3211, the snap ring 328 abuts against the second shaft sleeve 323, specifically, abut against the step 3218. The snap ring 328 prevents the shaft rod 325 from retreating from the second mounting hole 3233. During the process that the first shaft sleeve 321 jitters along the shaft rod 325, the snap ring 328 can prevent the shaft rod 325 from rotating, so that the snap ring 328 increases the resistance to the rotation of the first shaft sleeve 321, to provide a buffering effect.

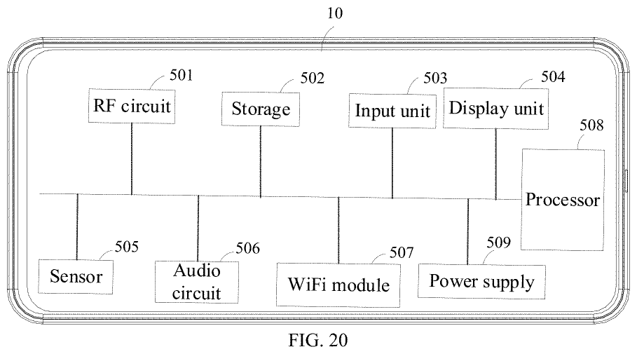

Referring to FIG. 20, which is a schematic structural diagram of the electronic device 10 provided in the embodiments of the present disclosure. The electronic device 10 may include a Radio Frequency (RF) circuit 501, a memory 502 including one or more computer-readable storage media, an input unit 503, a display unit 504, a sensor 505, an audio circuit 506, a Wireless Fidelity (WiFi) module 507, a processor 508 including one or more process cores, a power supply 509 and other components. Those skilled in the art can understand that, the electronic device 10 is not limited in the structure of the electronic device 10 shown in FIG. 20, and the electronic device 10 may include more or fewer components than those shown in the figure, or have a combination of some components or a different arrangement of the components.

The RF circuit 501 may be used to receive and send information, or to receive and send signals during a call. In particular, after the RF circuit 501 receives downlink information from a base station, it forwards the information to the one or more processor 208 for processing. In addition, the RF circuit 501 sends uplink data to the base station. Generally, the RF circuit 501 includes, but is not limited to, an antenna, at least one amplifier, a tuner, one or more oscillators, a Subscriber Identity Module (SIM) card, a transceiver, a coupler, a Low Noise Amplifier (LNA), a duplexer and the like. In addition, the RF circuit 501 may also communicate with other devices through wireless communication network. The wireless communication may use any communication standard or protocol, including but not limited to Global System of Mobile (GSM) communication, General Packet Radio Service (GPRS), Code Division Multiple Access (CDMA), Wideband Code Division Multiple Access (WCDMA), Long Term Evolution (LTE), E-mail, Short Messaging Service (SMS), etc.

The memory 502 is configured to store application programs and data. The application program stored in the memory 502 contains executable codes. The application programs may constitute various functional modules. The processor 508 performs various functional applications and data process by running the application programs stored in the memory 502. The memory 502 may mainly include a program storage area and a data storage area. The storage program area may store an operating system, application programs required by at least one function (such as a sound playback function, and an image playback function), etc. The data storage area may store data (such as audio data, and phone book) created during the use of the electronic device 10, etc. In addition, the memory 502 may include a high-speed random access memory, and may also include a non-volatile memory, such as at least one magnetic disk storage device, a flash memory device, or other volatile solid-state storage devices. Correspondingly, the memory 502 may further include a memory controller to allow the processor 508 and the input unit 503 to access the memory 502.

The input unit 503 may be configured to receive input numbers, character information or user characteristic information (such as fingerprints), and generate input signals corresponding to keyboard, mouse, joystick, optical or trackball inputs that are related to user settings and function control. In some embodiments, the input unit 503 may include a touch-sensitive surface and other input devices. The touch-sensitive surface, also called a touch screen or a touch pad, can collect a touch operation performed by the user on or near the touch-sensitive surface (for example, an operation performed by the user on or near the touch-sensitive surface with any suitable objects or accessories such as fingers and stylus), and drive a corresponding connection device according to a preset program. Optionally, the touch-sensitive surface may include a touch detection device and a touch controller. The touch detection device detects a touch position of the user and a signal generated by the touch operation, and transmits the signal to the touch controller. The touch controller receives the touch information from the touch detection device, converts the touch information into contact coordinates for sends them to the processor 508, and receives and executes commands sent by the processor 508.

The display unit 504 may be configured to display information input by the user or information provided to the user, and display various graphical user interfaces of the electronic device 10. The graphical user interface may be composed of graphics, texts, icons, videos, and any combination thereof. The display unit 504 may include a display panel. Optionally, the display panel may be configured in the form of a Liquid Crystal Display (LCD), an Organic Light-Emitting Diode (OLED), etc. Further, the touch-sensitive surface may cover the display panel. When detecting a touch operation on or near the touch-sensitive surface, the touch-sensitive surface transmits it to the processor 508 to determine a type of the touch event, and the processor 508 controls a corresponding visual output to be displayed on the display panel according to the type of the touch event. In FIG. 20, the touch-sensitive surface and the display panel are used as two independent components to implement the input and input functions, but in some implementations, the touch-sensitive surface and the display panel may be integrated to implement the input and output functions.

The electronic device 10 may also include at least one kind of sensor 505, such as a light sensor, a motion sensor, and other sensors. Specifically, the light sensor may include an ambient light sensor and a proximity sensor. The ambient light sensor adjusts brightness of the display panel according to brightness of the ambient light, and the proximity sensor closes the display panel and/or backlight when the electronic device 10 is moved to an ear of the user. As a kind of motion sensor, a gravity acceleration sensor can detect the magnitude of acceleration in various directions (usually in three axes), detect the magnitude and direction of gravity while at rest, and identify applications related to the phone posture (such as switching between landscape and portrait, related games, magnetometer posture calibration) and identify vibration for related functions (such as pedometer, and tapping), and the like. The electronic device 10 may also be equipped with other sensors such as gyroscope, barometer, hygrometer, thermometer, and infrared sensor, which are not exhaustive here.

The audio circuit 506 provides an audio interface between the user and the electronic device 10 via a speaker and a microphone. The audio circuit 506 converts the received audio data into an electric signal, and transmits the converted electric signal to the speaker; and the speaker converts the received electric signal into a sound signal for output. In another aspect, the microphone converts the collected sound signal into an electric signal, the audio circuit 506 receives and converts the electric signal into the audio data and outputs the converted audio data to the processor 508, and then the audio data processed by the processor 508 is sent to for example another electronic device 10 via the RF circuit 501, or the audio data processed by the processor 508 is output to the memory 502 for further processing. The audio circuit 506 may also include an earphone holder to provide communication between a peripheral earphone and the electronic device 10.

Wireless Fidelity (WiFi) belongs to a short-distance wireless transmission technology. The electronic device 10 may help the users receive and send emails, browse webpages, and access streaming media via the WiFi module 507. The WiFi module 507 provides the users with wireless broadband Internet access. Although FIG. 20 shows the WiFi module 507, it is understandable that the WiFi module 207 is not a necessary component of the electronic device 10, and can be omitted according to requirements without changing the essence of the invention.

The processor 508 is a control center of the electronic device 10, which sometimes referred to as a main controller. The processor 508 utilizes various interfaces and lines to connect the various parts of the entire electronic device 10, and performs various functions of the electronic device 10 and process data by running or executing the application programs stored in the memory 502 and invoking the data stored in the memory 502, so as to monitor the entire electronic device 10. Optionally, the processor 508 may include one or more process cores. Preferably, the processor 508 may integrate an application processor and a modem processor. The application processor mainly processes the operating system, user interfaces, and application programs, etc. The modem processor mainly processes wireless communication. It can be understood that, the above modem processor may not be integrated into the processor 508.

The electronic device 10 also includes the power supply 509 for supplying power to various components. Preferably, the power supply 509 may be logically connected with the processor 508 through a power management system, so that the functions, such as the charging, discharging, and power consumption management, can be performed through the power management system. The power supply 509 may also include one or more of components such as Direct Current (DC) or Alternating Current (AC) power supplies, a recharging system, a power failure detection circuit, a power converter or inverter, and a power status indicator.

Although it is not shown in FIG. 20, the electronic device 10 may also include a Bluetooth module and the like, which is not detailed here. In specific implementations, the various modules mentioned above may be implemented as independent entities, or may be combined arbitrarily as one or several entities, and the specific implementations of the above modules may refer to the previous method embodiments, which are not repeated here.

The technical features of the above-mentioned embodiments can be combined arbitrarily. In order to make the description concise, all possible combinations of the various technical features in the above embodiments are not described here; however, all of such combinations of the technical features should be considered to fall within the scope of the description as long as no contradiction is caused in such combinations.

The above-mentioned embodiments only illustrate several embodiments of the present disclosure, and the description thereof is relatively specific and detailed, which however should not be understood as limiting the scope of the present disclosure. It should be noted that, several modifications and improvements can also be made by those of ordinary skill in the art without departing from the concept of the present disclosure, all of which fall within the scope of protection of the present disclosure. Therefore, the scope of protection of the present disclosure should be subject to the appended claims.

What is claimed is:

1. An electronic device, comprising:
a main body comprising a display screen module, wherein the main body has a front side and a rear side opposite to the front side, the front side of the main body is defined as a side where a display area of the display screen module is located, a mounting groove is provided at the rear side of the main body, and a sound output channel is provided in a groove wall of the mounting groove and is communicated with the front side of the main body;
a mounting base comprising a receiver and a first camera module, wherein the mounting base is rotatable relative to the main body to switch between a first position and a second position;
wherein as the mounting base is in the first position, the mounting base is accommodated in the mounting groove, the first camera module is exposed to the rear side of the main body, and the receiver is enabled to output sound through the sound output channel; and
wherein as the mounting base is in the second position, the mounting base is out of the mounting groove, the first camera module is exposed to the front side of the main body, and the receiver is enabled to output the sound from the rear side of the main body.

2. The electronic device of claim 1, wherein the display screen module comprises a display screen and a screen protection cover arranged on the display screen, the main body further comprises a middle frame and a rear cover, the display screen module and the rear cover are respectively assembled at two opposite sides of the middle frame, the mounting groove extends to a side edge of the rear cover to define a first notch in the rear cover, and the mounting groove extends to a side edge of the middle frame to define a second notch in the middle frame, and the sound output channel is located in the middle frame.

3. The electronic device of claim 2, wherein the middle frame comprises a middle plate and an outer frame disposed at an outer periphery of the middle plate, the display screen module and the rear cover are respectively assembled, along a thickness direction of the electronic device, at two opposite sides of the middle plate, the outer frame is further disposed at an outer periphery of each of the display screen module and the rear cover, and the sound output channel is located in the outer frame.

4. The electronic device of claim 3, wherein the middle frame further comprises:
a first side wall and a second side wall disposed opposite to the first side wall; and
a third side wall and a bottom wall which are connected between the first side wall and the second side wall,
wherein the first side wall, the second side wall and the third side wall are disposed along an outer periphery of the bottom wall, each of the first side wall, the second side wall and the third side wall is disposed on and perpendicular to the middle plate, the mounting groove is defined by the bottom wall, the first side wall, the second side wall and the third side wall, and the sound output channel is located in the bottom wall.

5. The electronic device of claim 4, wherein a first step having a step surface is formed on a side of at least one of the first side wall, the second side wall, and the third side wall that is away from the mounting groove, and a height of the step surface is lower than a height of an end face of each of the first side wall, the second side wall and the third side wall that is away from the bottom wall; and
wherein the rear cover is attached onto the step surface, and a side of each of the first side wall, the second side wall, and the third side wall that is away from the bottom wall passes through the first notch.

6. The electronic device of claim 4, wherein a second camera module is located on a side of the third side wall that is away from the mounting groove, the second camera module is accommodated in a mounting space defined between the middle frame and the rear cover, and the second camera module is adjacent to the third side wall and faces towards the rear cover, and
wherein the rear cover is provided with a light-transmission area, the light-transmission area is configured to allow the second camera module to receive light.

7. The electronic device of claim 4, wherein the first side wall is provided with a shaft hole communicated with the mounting groove; and
wherein the electronic device further comprises a driving mechanism disposed within a mounting space defined between the middle frame and the rear cover, the driving mechanism comprises a driver and an output shaft connected with the driver, the output shaft of the driving mechanism passes through the shaft hole and is connected with the mounting base, the driver is configured to drive the output shaft to rotate to cause the mounting base to rotate to the first position or the second position.

8. The electronic device of claim 7, wherein the shaft hole extends to the outer frame to define a first recess in the outer frame, the driving mechanism is connected with the middle plate, and at least a part of the output shaft is accommodated in the first recess.

9. The electronic device of claim 4, wherein the second side wall is provided with a hole penetrating the second side wall and communicated with the mounting groove, and the hole extends to the outer frame to define a second recess in the outer frame; and
wherein the electronic device further comprises a wire pipe, the wire pipe passes through the hole to access the mounting base, and at least a part of the wire pipe is accommodated in the second recess.

10. The electronic device of claim 7, wherein the output shaft comprises a first shaft sleeve and a second shaft sleeve, the first shaft sleeve is driven by the driver, and the second shaft sleeve is connected with the mounting base; and
wherein one of the first shaft sleeve and the second shaft sleeve is provided with a clamping slot, another of the first shaft sleeve and the second shaft sleeve is provided with a protrusion, the protrusion is received in the clamping slot to enable the first shaft sleeve to drive, via the second shaft sleeve, the mounting base to rotate relative to the main body.

11. The electronic device of claim 10, wherein the output shaft comprises a shaft rod, an elastic member and a position-limiting member, the first shaft sleeve is provided with a first mounting hole, the second shaft sleeve is provided with a second mounting hole, the first mounting hole runs through the first shaft sleeve along an axial direction of the first shaft sleeve, and the second mounting hole runs through the second shaft sleeve along an axial direction of the second shaft sleeve;
wherein the shaft rod comprises a shaft body and a connection portion connected with the shaft body, a part of the shaft body passes through the first mounting hole, another part of the shaft body passes through the second mounting hole, and the connection portion is received in the first mounting hole;
wherein a second step is formed on an inner wall of the first mounting hole, an inner diameter of a part of the first mounting hole where the step is formed is larger than an inner diameter of other part of the first mounting hole, the elastic member is accommodated in the part of the first mounting hole having the larger inner diameter and is sleeved on the shaft body, one end of the elastic member abuts against the second step, and another end of the elastic member abuts against the connection portion;
wherein the connection portion is provided with a position-limiting hole, the first shaft sleeve is provided with a clamping hole along a radial direction of the first shaft sleeve, the position-limiting member passes through the clamping hole and is fixed to the first shaft sleeve, and the position-limiting member passes through the position-limiting hole; and
wherein rotation of the first shaft sleeve drives, via the position-limiting member, the shaft rod to rotate, and as the mounting base is in the first position or the second position, the protrusion is detachable from the clamping slot to enable the first shaft sleeve to move in a direction away from the second shaft sleeve and compress the elastic member, and enable the position-limiting member to move within the position-limiting hole in the direction away from the second shaft sleeve.

12. The electronic device of claim 11, wherein the output shaft comprises a snap ring, and the snap ring is clamped at an end of the shaft body that is away from the connection portion, and
wherein a third step is formed on an inner wall of the second mounting hole, an inner diameter of a part of the second mounting hole where the third step is formed is larger than the inner diameter of other part of the second mounting hole, the snap ring is configured to abut against the third step of the second shaft sleeve during a process that the protrusion is detached from the clamping slot.

13. The electronic device of claim 1, wherein the mounting base comprises a base body and a cover plate, an accommodation groove is defined in the base body, the receiver and the camera module are accommodated in the accommodation groove, and the cover plate covers the accommodation groove;
wherein a first sound hole is provided in the cover plate, the first sound hole is configured for sound output of the receiver;
wherein as the mounting base is in the first position, the cover plate is located at a side of the base body toward the display screen module, and the first sound hole is communicated with the sound output channel, and
wherein as the mounting base is in the second position, the cover plate is exposed to the rear side of the main body.

14. The electronic device of claim 13, wherein the mounting base further comprises a press plate,
two opposite sides of the press plate respectively abut against the receiver and the cover plate; and
wherein a second sound hole is provided in the press plate, the second sound hole is also configured for the sound output of the receiver, and the second sound hole is communicated with the first sound hole.

15. The electronic device of claim 13, wherein the base body is provided with a first through hole communicated with the accommodation groove, the first through hole is located in a side wall of the base body that is opposite to the cover plate, a first dent is disposed on the side wall at a side away from the accommodation groove, the first through hole is separated from the first dent; and
wherein the first camera module comprises at least one camera and a flash, the first through hole is configured to receive light for the at least one camera, and the first dent is configured to mount the flash.

16. The electronic device of claim 15, wherein a second dent is provided on the side wall at the same side as the first dent, the first through hole and the first dent are located at a bottom of the second dent;
wherein the mounting base further comprises a lens cover, the lens cover is disposed in the second dent and covers the at least one camera; and
wherein a light-transmission hole is provided in the lens cover, and the flash passes through the light-transmission hole.

17. The electronic device of claim 16, wherein a bottom of the first dent is provided with a second through hole communicated with the accommodation groove, the mounting base further comprises a flexible circuit board, and the flexible circuit board passes through the second through hole and is electrically connected with the flash.

18. An electronic device, comprising:
a main body defining a mounting groove at a rear side thereof, wherein a groove wall of the mounting groove is provided with a sound output channel communicated with a front side of the main body;
a mounting base comprising a receiver and a camera module, wherein the mounting base is rotatable relative to the main body to switch between a first position and a second position;
wherein the electronic device defines a first state and a second state;
wherein in the first state, the mounting base is accommodated in the mounting groove, the camera module is exposed to the rear side of the main body, and the receiver is enabled to output sound through the sound output channel; and
wherein in the second state, the mounting base is out of the mounting groove, the camera module is exposed to the front side of the main body, and the receiver is enabled to output the sound from the rear side of the main body.

19. The electronic device of claim 18, wherein the main body comprises a middle frame, a rear cover, and a display screen module, the display screen module and the rear cover are respectively assembled at two opposite sides of the middle frame, the front side of the main body is defined as a side where a display area of the display screen module is located, and the sound output channel is located in the middle frame.

20. An electronic device, comprising:
a main body comprising a display screen module, a middle frame and a rear cover, wherein the display screen module and the rear cover are assembled at two opposite sides of the middle frame, a mounting groove is defined in the middle frame and the rear cover, the middle frame is provided with a sound output channel, the sound output channel is communicated with the mounting groove and a front side of the main body, and the front side is defined as a side of the main body where a display area of the display screen module is located;
a mounting base comprising a receiver and a camera module, wherein the mounting base is rotatable relative to the main body to define a first state and a second state of the electronic device;
wherein in the first state, the mounting base is accommodated in the mounting groove, the camera module is exposed to a rear side of the main body, and the receiver is enabled to output sound through the sound output channel; and
wherein in the second state, the mounting base is out of the mounting groove, the camera module is exposed to the front side of the main body, and the receiver is enabled to output the sound from the rear side of the main body.
